(19) United States
(12) Patent Application Publication
(10) Pub. No.: US 2007/0043816 A1
(43) Pub. Date: Feb. 22, 2007

(54) Electronic mail forming method and recording medium storing program

(75) Inventor: Takei Ishibashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/289,612

(22) Filed: Nov. 30, 2005

(30) Foreign Application Priority Data
Aug. 18, 2005 (JP) 2005-237527

(51) Int. Cl. G06F 15/16

(52) U.S. Cl. 709/206

(57) ABSTRACT

Disclosed is an electronic mail forming method comprising the steps of: classifying a plurality of electronic mail addresses into a plurality of groups; forming, for each of the groups classified in the classifying step, at least one electronic mail in which only electronic mail address(es) classified into the corresponding one of the groups is designated as destination(s); and sending the electronic mails formed in the forming step.

### BACKGROUND

1. Field of the Invention

The present invention relates to an electronic mail forming method in which electronic mails are formed according to destinations and are sent, and a recording medium storing the program thereof.

2. Description of Related Art

In recent years, an electronic mail forming method has been developed, in which the electronic mail is to exchange information between terminal apparatuses connected to a network such as LAN and WAN through a mail server on the network. In such electronic mail forming method, an electronic mail is sent and received, in which a destination thereof is specified with an electronic mail address and the electronic mail is sent to the specified destination.

In such electronic mail forming method, information is exchanged only between a sender and receiver corresponding to a destination specified by the sender via an electronic mail. When information is exchanged by using an electronic mail only between persons in charge in handling a predetermined business, a manager who manages the business cannot know the information. Thus, it has sometimes been problematic to handle the business appropriately and effectively.

JP 2003-16004A discloses an electronic mail delivery system in which a mail server comprises a personal data managing region which stores personal information such as a department, duty position and electronic mail address of a member in an organization, and an organization information managing region which stores organization information. The electronic mail delivery system comprises a sender adding program which determines a manager of a sender as a browser according to the personal data managing region and a group information managing region, when the sender sends an electronic mail, and adds an electronic mail address of the browser to the destination.

However, in the conventional electronic mail forming method, all destinations of an electronic mail are displayed to each destination when a plurality of addresses of different groups are set as destinations in sending the electronic mail. Thus, it is problematic that a person can know electronic mail addresses of the other person who has any direct relationship with him/her.

For example, when destinations of an electronic mail include persons in a company (in-house-persons) and persons outside the company (outside-persons), the delivered electronic mail displays all of the electronic mail addresses of the in-house-person and the outside-person. Thus, the electronic mail addresses are inadvertently known between the outside-persons or between the in-house-person and the outside-person each other, who have any direct relationship between them.

In order to ensure security of an electronic mail address of personal information and company confidential, it is not desired in some cases that an electronic mail address is carelessly known outside the office. In such cases, the problem can be dissolved by classifying destinations into a plurality of groups such as in-house-persons and outside-persons outside the office, and forming and sending the electronic mail for each group. However, it is a time-consuming work for a user since the user has to form the electronic mails for the groups manually, respectively. Further, it is also problematic that a plurality number of sendings decreases sending efficiency.

### SUMMARY

The present invention has been achieved with consideration of the above circumstances, and one of the objects of the present invention is to improve efficiency of sending electronic mails and usability while security of electronic mail addresses are ensured.

In order to achieve one of the above mentioned objects, according to one embodiment reflecting the first aspect of the invention, an electronic mail forming method comprises the steps of: classifying a plurality of electronic mail addresses into a plurality of groups; forming, for each of the groups classified in the classifying step, at least one electronic mail in which only electronic mail address(es) classified into the corresponding one of the groups is designated as destination(s); and sending the electronic mails formed in the forming step.

Preferably, the electronic mail forming method further comprises the step of: accepting an input of a plurality of the electronic mail addresses, wherein in the classifying step, a plurality of the electronic mail addresses accepted in the accepting are classified into a plurality of the groups.

Preferably in the accepting step, message data is accepted, and in the forming step, the message data accepted in the accepting is applied as common message data to the classified groups.

Preferably, the electronic mail forming method further comprises the step of: setting a group number by accepting an indication of the number of the groups to which the electronic mails are classified, wherein in the classifying step, a plurality of the electronic mails are classified according to the group number accepted in the setting step.

Preferably in the classifying step, a selection of the group is requested for each of the electronic mail addresses.

Preferably in the classifying step, a plurality of the electronic mail addresses are classified into a plurality of the groups according to domain names included in the electronic mail addresses accepted in the accepting step.

Preferably in the classifying step, a plurality of the electronic mail addresses are classified into a plurality of the groups based on a predetermined rule.

Preferably, the predetermined rule includes referring to a list of the electronic mail addresses in which the electronic mail addresses corresponds to attribute information, and in the classifying step, a plurality of the electronic mail addresses are classified into a plurality of the groups according to the attribute information.

Preferably in the classifying step, the electronic mail addresses to which the attribute information is not set are classified into a group different from the group(s) of the electronic mail addresses to which the attribute information is set.

Preferably the classifying step comprises the step of accepting an input of the electronic mail addresses with respect to the groups.

Preferably in the accepting step of the input of the electronic mail addresses, input columns of the electronic mail addresses are provided in which the number of the input columns corresponds to a predetermined number of the groups, and in the classifying step, the electronic mail addresses are classified with respect to the input columns to which the electronic mail addresses have been input.

In order to achieve one of the above mentioned objects, according to one embodiment reflecting the second aspect of the invention, in a recording medium which stores a computer-executable program, the program causes a computer to carry out the procedures of: classifying a plurality of electronic mail addresses into a plurality of groups; forming, for the groups classified in the classifying step, at least one electronic mail in which only electronic mail address(es) classified into the corresponding one of the groups is designated as destination(s); and sending the electronic mails formed in the forming step.

Preferably, the program further causes the computer to carry out a procedure of: accepting an input of a plurality of the electronic mail addresses, and in the classifying procedure, a plurality of the electronic mail addresses accepted in the accepting are classified into a plurality of the groups.

Preferably in the accepting procedure, message data is accepted, and in the forming procedure, the message data accepted in the accepting procedure is applied as common message data to the classified groups.

Preferably, the program further causes the computer to carry out the procedure of: setting a group number by accepting an indication of the number of the groups to which the electronic mails are classified, and in the classifying procedure, a plurality of the electronic mails are classified according to the group number accepted in the setting.

Preferably in the classifying procedure, a selection of the group is requested for each of the electronic mail addresses.

Preferably in the classifying procedure, a plurality of the electronic mail addresses are classified into a plurality of the groups according to domain names included in the electronic mail addresses accepted in the accepting procedure.

Preferably in the classifying procedure, a plurality of the electronic mail addresses are classified into a plurality of the groups based on a predetermined rule.

Preferably, the predetermined rule includes referring to a list of the electronic mail addresses in which the electronic mail addresses corresponds to attribute information, and in the classifying procedure, a plurality of the electronic mail addresses are classified into a plurality of the groups according to the attribute information.

Preferably in the classifying procedure, the electronic mail addresses to which the attribute information is not set is classified into a group different from the group(s) of the electronic mail addresses to which the attribute information is set.

Preferably, the classifying procedure comprises a procedure of accepting an input of the electronic mail addresses with respect to the groups.

Preferably in the accepting procedure of accepting the input of the electronic mail addresses, input columns of the electronic mail addresses are provided in which the number of the input columns corresponds to a predetermined number of the groups, and in the classifying procedure, the electronic mail addresses are classified with respect to the input columns to which the electronic mail addresses have been input.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a schematic constitutional view of an electronic mail system A of embodiment 1;

FIG. 2 is a control block diagram of a terminal apparatus 1 of the electronic system A of embodiment 1;

FIG. 3 is one example of a group selection screen G1;

FIG. 4 is one example of a group division selection screen G0;

FIG. 5 is one example of an address book DB 11b;

FIG. 6 is one example of a domain DB 11c;

FIGS. 7A and 7B are a main flowchart of an electronic mail forming process of the embodiment 1;

FIGS. 8A and 8B are a flowchart in the case of determining a group classification according to an address book DB, executed in step S9;

FIG. 9 is a flowchart in the case of determining a group classification according to an address book DB, executed in step S9 (continuation of FIGS. 8A and 8B);

FIG. 10 is one example of a reference table T1 where electronic mail addresses are sorted according to each group name formed in step S23 and identification numbers are given thereto;

FIG. 11 is one example of a registration table T2 in the case that step S32 is YES;

FIG. 12 is a flowchart in the case of determining the group classification according to a domain DB, executed in step S11;

FIG. 13 is a flowchart in the case of classifying into a plurality of groups according to a selection designation of the electronic mail addresses directed by a user, executed in step S13;

FIG. 14 is a control block diagram of a terminal apparatus 3 of embodiment 2;

FIG. 15 is one example of an electronic mail forming screen G3 of embodiment 2; and

FIG. 16 is a flowchart of an electronic mail forming process of embodiment 2.

### DETAILED DESCRIPTION OF THE PREFERRED EMBODIMENTS

### Embodiment 1

Hereinafter, embodiment 1 of the present invention will be described in detail with reference to the drawings.

First of all, the constitution thereof is described.

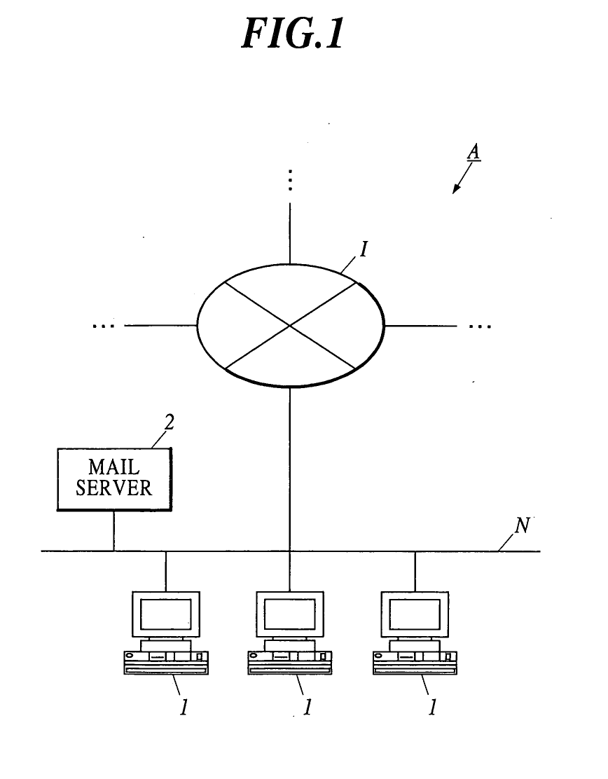

FIG. 1 shows a schematic constitutional view of the electronic mail system A of embodiment 1.

The electronic mail system A shown in FIG. 1 has a constitution in which a plurality of terminal apparatuses 1 can access to a mail server 2 connected trough a network N, and is connected to an Internet line I.

An electronic mail formed in the terminal apparatus 1 is sent to a mail server 2. The mail server 2 makes the terminal apparatus 1 connect to the Internet so as to send the received electronic mail. The sent electronic mail is sent to a designated user (terminal apparatus) according to an electronic mail address of the electronic mail through a plurality of mail servers on the Internet.

The mail server 2 is a server which is specially directed to mail management among various types of servers provided by a provider or personal computer telecommunications carrier, and comprises a SMTP (simple mail transfer protocol) server to send an electronic mail to a user of the other network, a mail box to store an electronic mail sent to a user of the own network with respect to each mail address and a POP (post office protocol) server to read out an electronic mail addressed to a certain user from the mail box and send it to the user according to a reception request from the user.

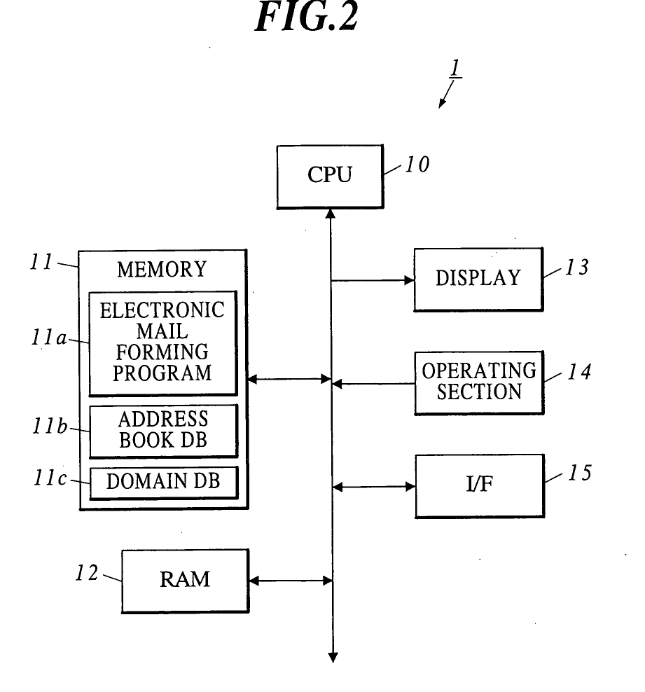

FIG. 2 shows a control block diagram of the terminal apparatus 1 of the embodiment 1.

As shown in FIG. 2, the terminal apparatus 1 comprises a CPU (central processing unit) 10, memory 11, RAM (random access memory), display 13, operating section 14 and I/F 15, which are connected electrically with one another.

The CPU 10 readouts a system program, various processing programs and various data stored in the memory 11, expands them to the RAM 12, and performs a central control of operations of sections in the terminal apparatus 1 according to the expanded programs and data. The CPU 10 controls timing of the whole system, storing of data by use of the RAM 12 and operation with respect to other applications.

When an electronic mail forming program is executed, the CPU 10 offers an input step, classification step, electronic mail forming step and sending step, which accept message data and header data at the operating section 14, when a plurality of electronic mail addresses are accepted as destinations included in the header data, classify the accepted mail addresses into a plurality of groups (destination group), form a plurality of electronic mails each of which have destinations of only one group of classified mail addresses respectively and common message data which is the accepted message data, and send a plurality of the formed electronic mails.

The message data represents a message body composed of characters and symbols or an attached image file or document file.

The header data represents sent date of the electronic mail, electronic mail address of a sender of the electronic mail, title of the electronic mail and destination of the electronic mail.

The destination in the embodiment 1 corresponds to “To” which denotes a regular destination in a designating method of the destination for sending the electronic mail, and has different meaning from those of “Cc.” (Carbon copy) which denotes a destination to which a message identical to the message sent to the regular destination is to be sent and “Bcc.” (Blind Carbon Copy) which denotes a destination to which a message identical to the message sent to the regular destination is to be sent but the destination is not displayed in the electronic mail sent to the other destination(s).

When a plurality of electronic mail addresses are classified into a plurality of groups, the CPU 10 performs the classification according to the following conditions.

A plurality of the electronic mail addresses are respectively classified into a plurality of groups according to a predetermined rule and the attributed information of each electronic mail address. The electronic mail addresses to which the attributed information is not set may be classified into a group different from groups of the electronic mail addresses to each of which the attributed information is set.

The predetermined rule includes a rule to classify according to group name registered to a group item of the after-mentioned address book DB 11b, or a rule to classify according to whether or not domains of the accepted electronic mail addresses are registered on the after-mentioned domain DB 11c.

The attributed information represents characteristics of the predetermined rule, i.e. criteria for classifying the electronic mail addresses into a plurality of groups. When the predetermined rule is based on the address book, it represents information of a group name registered to the group item of the electronic mail addresses registered to the address book DB 11b, and when the predetermined rule is based on the domain name, it represents information of whether or not the electronic mail addresses are registered to the domain DB 11c.

As described above, the classification of the electronic mail addresses can be determined based on the attribute information of the predetermined rule. Thus, it becomes possible to ensure security of the electronic mail addresses. Further, the electronic mail addresses to which the attribute information is not set can be classified into a different group from groups of the electronic mail addresses to each of which the attribute information is set.

Further, a plurality of mail addresses may be classified into a plurality of groups including electronic mail addresses of same domain name based on the domain names included in a plurality of the mail addresses.

When a plurality of the mail addresses are classified based on the domain name, the electronic mails are formed for each group of electronic mail addresses having same domain name. Thus, security of the electronic mail addresses can be ensured, since it becomes possible to prevent persons having no relationship between them from being included in destinations of the one electronic mail.

The further possible case is that, when the number of the groups are accepted on the operating section 14, the display 13 displays a group selection screen to request group setting for each electronic mail address based on the accepted number of groups, and a plurality of the electronic mail addresses are classified based on the information of selection designated on the group selection screen.

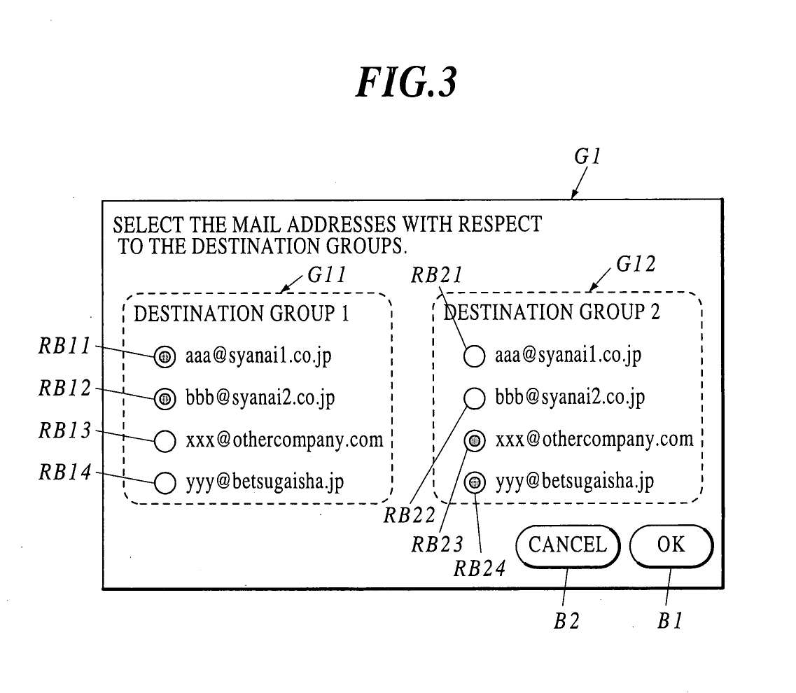

FIG. 3 shows one example of the group selection screen G1.

The group selection screen shown in FIG. 3 is one example of the group selection screen where the number of groups accepted on the operating section 14 is two. In FIG. 3, destination group selection areas G11 and G12 corresponding to the number of groups, an OK button B1 and cancel button B2 are provided. Each of the destination group selection areas G11 and G12 displays all of the electronic mail addresses accepted on the operating section 14. Each of the electronic mail addresses is displayed corresponding to radio buttons RB11 to RB14 and RB21 to RB24. When the radio button is selected, the corresponding electronic mail address is selected as the destination of the electronic mail of the destination group selecting area. When the OK button B1 is pushed, the designations made on the group selection screen G1 are fixed. When the cancel button B2 is pushed, the designation made on the group selection screen G1 is deleted.

In the group selection screen G1 shown in FIG. 3, because the radio buttons RB11 and RB12 are selected, the electronic mail addresses of “aaa@syanai1.co.jp” and “bbb@syanai2.co.jp” corresponding to the radio buttons RB11 and RB12 are selected as the destinations of the electronic mails corresponding to the destination group selection area G11. Similarly, as the destinations of the electronic mails corresponding to the destination group selecting area G12, the electronic mail addresses of “xxx@othercompany.com” and “yyy@betsugaisha.jp” corresponding to the radio button RB23 and RB24 are selected.

As described above, a plurality of the electronic mail addresses can be classified to the desired number of the groups, and the user can be promoted to set the group setting for each electronic mail. Thus, since the user can classify the electronic mail addresses into desired groups, it is possible to improve usability.

The above-described classification methods are selected based on an operation signal which is made on the operating section 14 with respect to the group division selection screen displayed on the display 13. The group division selection screen is displayed when it is judged a plurality of electronic mail addresses are input to a destination input column.

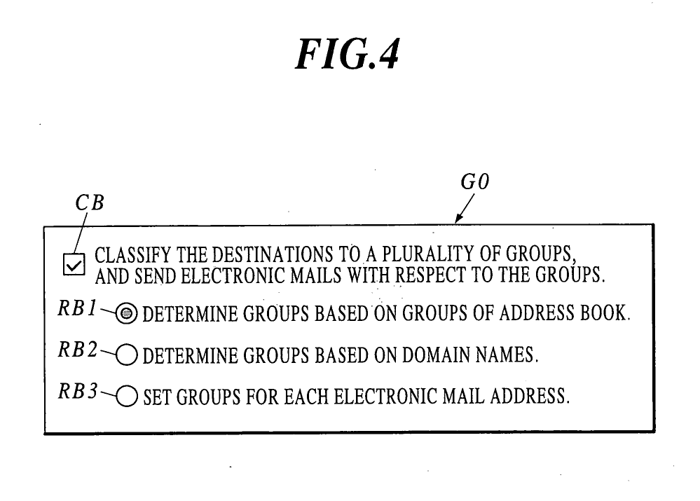

FIG. 4 shows one example of the group division selection screen G0.

The group selection screen G0 shown in FIG. 4 comprises a check box CB as well as a message which requests a selection whether or not to classify a plurality of the electronic mails input to the destination input column into a plurality of groups. When the check box CB is checked, the radio buttons RB1 to RB3 to select the above-described classification methods become selectable.

In the group division selection screen G0 shown in FIG. 4, the radio button RB1 is selected as the classification method, so that a selected rule is to classify into groups according to each group name registered to the group item of the address book DB 11b.

The memory 11 comprises a nonvolatile recording medium such as a ROM (read only memory) and an HDD (hard disk drive), and stores in the recording medium a system program corresponding to the terminal apparatus 1, various control programs and various application programs executed by the CPU 10, and various data required to process on the various programs.

Further, the memory 11 previously stores an electronic mail sending and receiving program to manage sending and receiving of the electronic mail between the mail server 2 and terminal apparatus 1, executed in the embodiment 1, an electronic mail forming program 11a executed in the electronic mail sending and receiving program, address book DB 11b, domain DB 11c, and various data required to form an electronic mail.

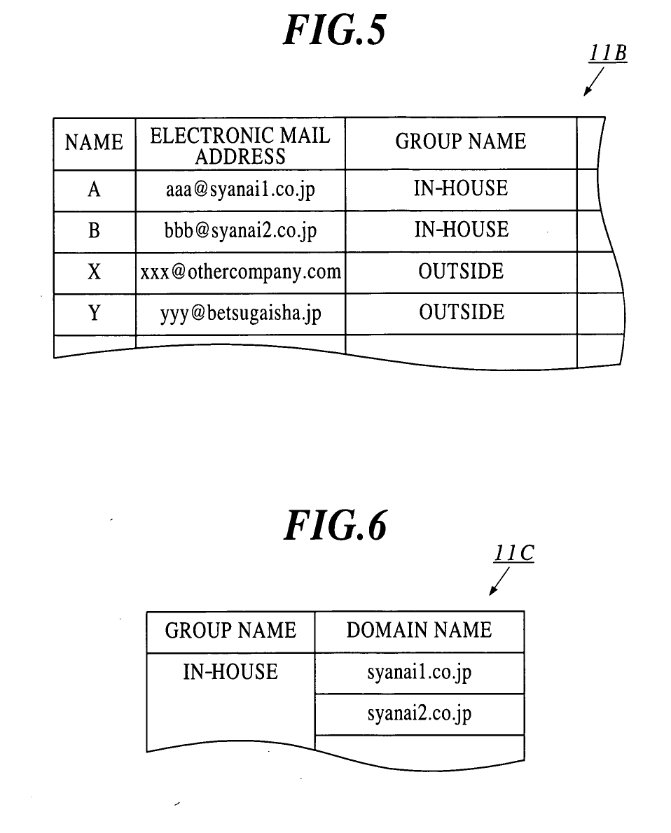

FIG. 5 shows one example of the address book DB 11b.

As shown in FIG. 5, a list of the electronic mail addresses of the destinations is previously stored in the address book DB 11b. An electronic mail address, group name, telephone number, address and the like are previously stored corresponding to a person or association to be the destination. The content of the address book DB 11b can be added, deleted and changed according to an operation of the user on the operating section 14.

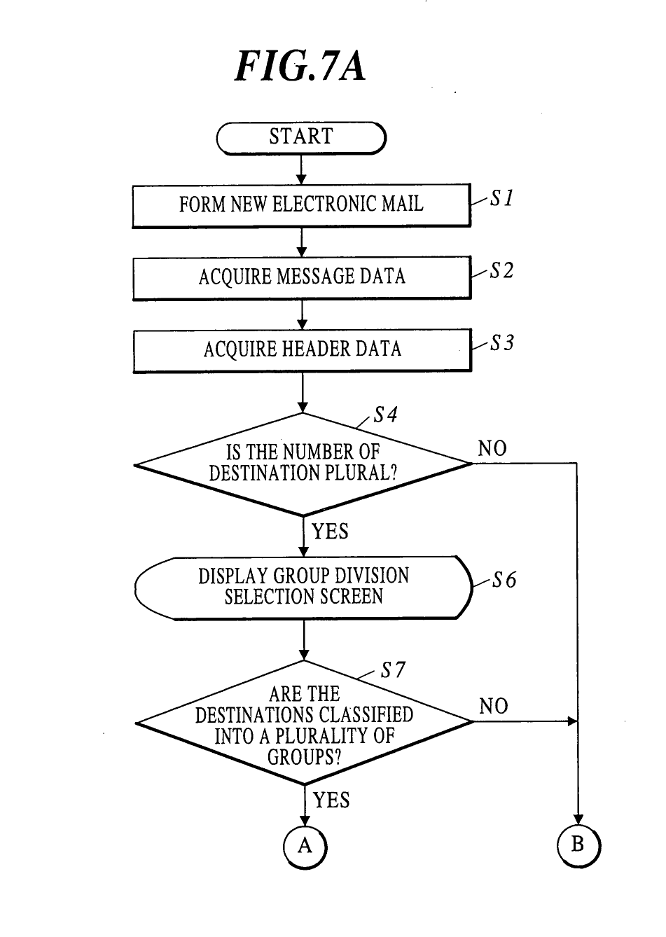

FIG. 6 shows one example of the domain DB 11c.

As shown in FIG. 6, a plurality of domain names each corresponding to a group name are registered. A plurality of electronic mail addresses whose domain names are registered to one group name of the domain DB 11c can be classified into one group. For example, group companies or affiliated companies having different domain names can be classified into one group. The contents of the domain DB 11c can be added, deleted and changed according to an operation of the user on the operating section 14.

The RAM 12 is a temporal storage for a program readout from the storage 11, input or output data and parameter in various processes executed by the CPU 10.

The display 13 comprises a LCD (liquid crystal display) or the like, and displays various screens on a display screen according to a display signal input from the CPU 10.

The operating section 14 comprises a keyboard composed of numeric keys, character keys, cursor shift key, various function keys and the like, a pointing device such as a mouse, and the like. The operating section 14 outputs a depression signal of the keyboard and an operation signal of the mouse to the CPU 10 as input signals.

The I/F 15 comprises various interfaces such as a network interface card (NIC), modem (modulator-demodulator) and USB, and sends and receives information to and from equipment connected to communicate with each other.

Next, operation of the embodiment 1 is described.

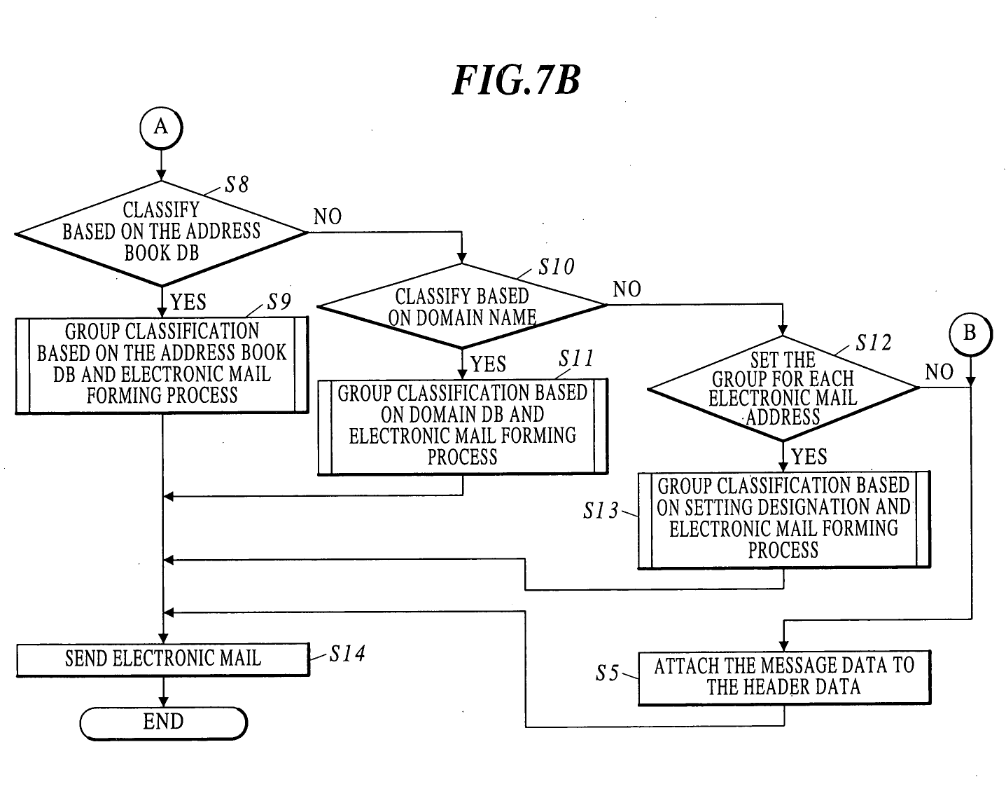

FIGS. 7A and 7B show a main flowchart of the electronic mail forming process of the embodiment 1.

The main flowchart of the electronic mail forming process shown in FIGS. 7A and 7B is offered by software processing which is achieved by cooperation of the CPU 10, memory 11 and the programs and various data stored in the RAM 12.

First, when the operating section 14 accepts a designation of the user to form new mail (step S1), the display 13 displays a new electronic mail screen on the display screen. The user inputs message data on the operating section 14 to the new electronic mail screen, so that the message data is obtained (step S2), and the user also inputs a header data, so that the header data is obtained (step S3).

When the header data is obtained, it is judged whether the total number of the electronic mail address(es) included in the header data is plural or not (step S4).

When it is judged the total number of the electronic mail address is not plural (i.e. singular) (step S4; No), the message data is attached to the header data so as to form the electronic mail (step S5), and the process shifts to step S14.

When it is judged the total number of the electronic mail address is plural (step S4; Yes), the group division selection screen is displayed on the display screen of the display 13 (step S6), and a group division selection designated by the user is accepted.

It is judged whether a plurality of the electronic mail addresses are classified into a plurality of groups or not, for example, whether the check box CB on the group division selection screen is checked or not (step S7).

When it is judged that a plurality of the electronic mail addresses are not classified into a plurality of groups, for example, the check box CB is not checked (step S7; No), the process shifts to step S5.

When it is judged that a plurality of the electronic mail address are classified into a plurality of groups, for example, the check box CB is checked (step S7; Yes), it is judged whether the classification to the groups is performed based on the address book DB or not, for example, whether the radio button R1 is checked or not (step S8).

When it is judged that the classification to groups is performed based on the address book DB, for example, the radio button R1 is checked (step S8; Yes), the electronic mail forming process to classify into a plurality of groups based on the address book DB is executed (step S9), and the process shifts to step S14.

When it is judged that the classification to groups is not performed based on the address book DB, for example, the radio button R1 is not checked (step S8; No), it is judged whether the classification to groups is performed based on domain name or not, for example, whether the radio button R2 is checked or not (step S10).

When it is judged that the classification to groups is performed based on the domain DB, for example, the radio button R2 is checked (step S10; Yes), an electronic mail forming process to classify into a plurality of groups based on the domain DB is executed (step S11), and the process shifts to step S14.

When it is judged that the classification to groups is not performed based on the domain DB, for example, the radio button R2 is not checked (step S10; No), it is judged whether the classification to groups is set to each of the electronic mail addresses or not, for example, the radio button R3 is checked or not (step S12).

When it is judged that the classification to groups is set to each of the electronic mail addresses, for example, the radio button R3 is checked (step S12; Yes), the electronic mail forming process to classify into a plurality of groups based on the user's selection of the electronic mail addresses is executed (step S13), and the process shifts to step S14.

When it is judged that the classification to groups is not set to each of the electronic mail addresses, for example, the radio button R3 is not checked (step S12; No), the process shifts to step S5.

Then, after the electronic mail is formed (after step S5, step S9, step S11 or step S13), the formed electronic mail is sent to the electronic mail address set as the destination (step S14), and the process ends.

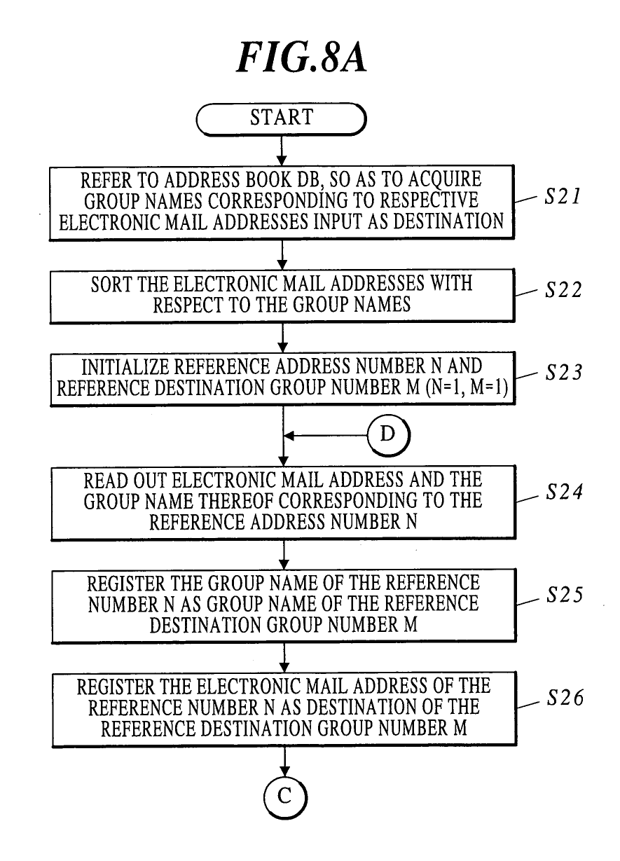

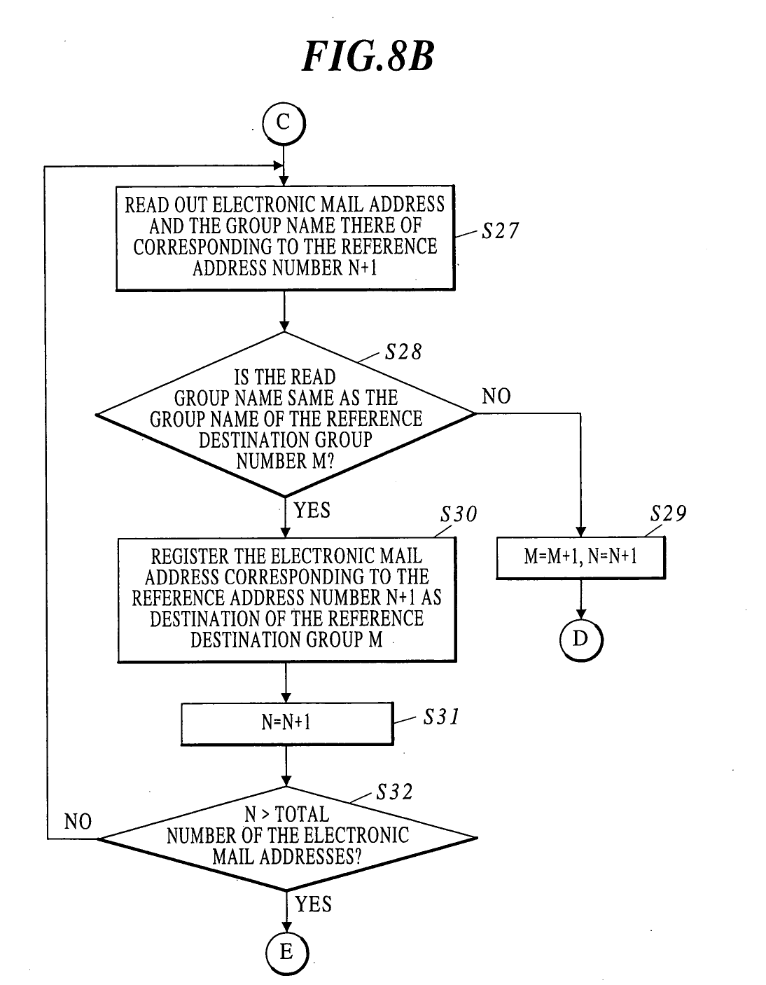

FIGS. 8A, 8B and 9 are flowcharts in the case of determining a group classification according to an address book DB, executed in step S9.

When it is judged that the classification to groups is performed based on the address book DB, for example, the radio button R1 is checked, the address book DB is referred to obtain the group name corresponding to respective electronic mail addresses input as destination (step S21), the electronic mail addresses are sorted according to each group name, and the reference table T1 where identification number is given is formed (step S22).

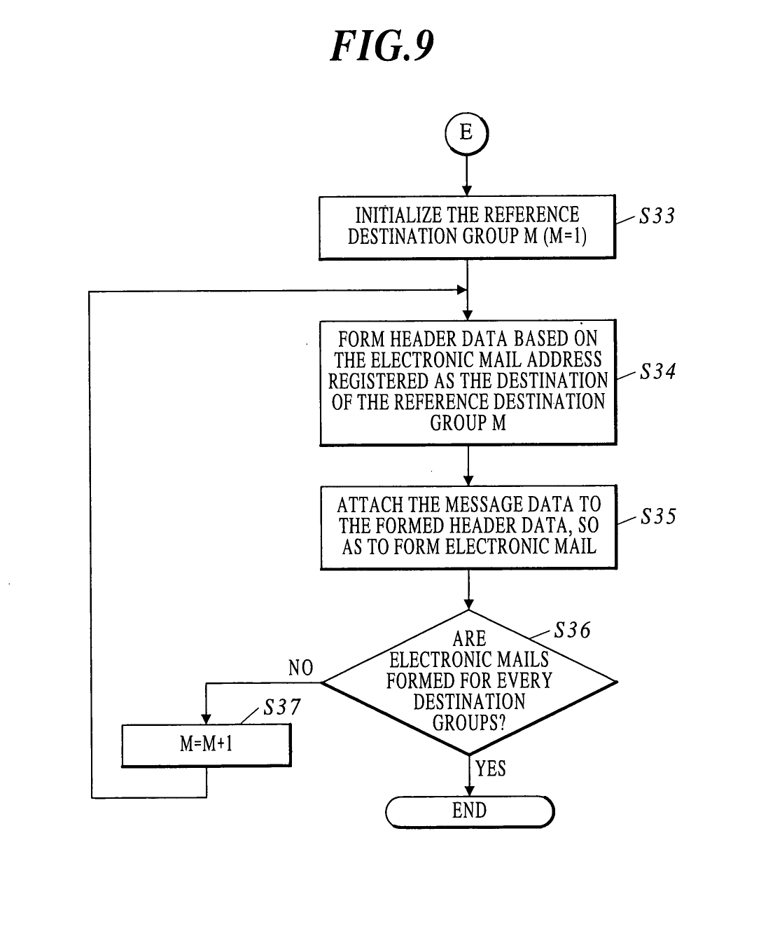

FIG. 10 is one example of a reference table T1 where electronic mail addresses are sorted according to each group name formed in step S23 and identification numbers are given thereto. As shown in FIG. 10, the reference table T1 is sorted so that the electronic mail addresses having same group name are consecutive, and the identification numbers to identify respective electronic mail addresses are given thereto.

A reference address number N and reference destination group number M are initialized (set as N=1 and M=1) (step S23), in which a reference address number N is the identification number of the electronic mail address to be referred and a reference destination group number M is the identification number of the destination group to be referred on the registration table T2 where the electronic mail addresses are classified into destination group and registered.

The electronic mail address and group name corresponding to the reference address number N is read out from the reference table (step S24).

The read out group name is registered as the group name of the destination group of the reference group number M (step S25), and the read out electronic mail address is registered as the destination of the destination group of the reference destination group number M (step S26).

The electronic mail address and group name corresponding to the identification number of the electronic mail address which is the reference address number N plus 1 is read out (step S27).

It is judged whether the read group name is same as the group name registered to the reference destination group M or not (step S 28).

When it is judged that the read out group name is not same as the group name registered to the reference destination group M (step S28; No), 1 is added to the reference destination group number M and reference address number N respectively (step S29), and the process shifts to the step S24.

When it is judged that the read out group name is same as the group name registered to the reference destination group M (step S28; Yes), the electronic mail address corresponding to the identification number of the electronic mail address which is the reference address number N plus 1 is registered and added to the destination of the destination group of the reference destination group number M (step S30).

Then, 1 is added to the reference address number N (step S31), and it is judged whether the reference address number N is larger than the total number of the electronic mail addresses or not (step S32).

When it is judged that the reference address number N is not larger than the total number of the electronic mail addresses (step S32; No), the process shifts to step S27.

When it is judged that the reference address number N is larger than the total number of the electronic mail addresses (step S32; Yes), all the electronic mail addresses are registered to the registration table T2 with respect to each destination group.

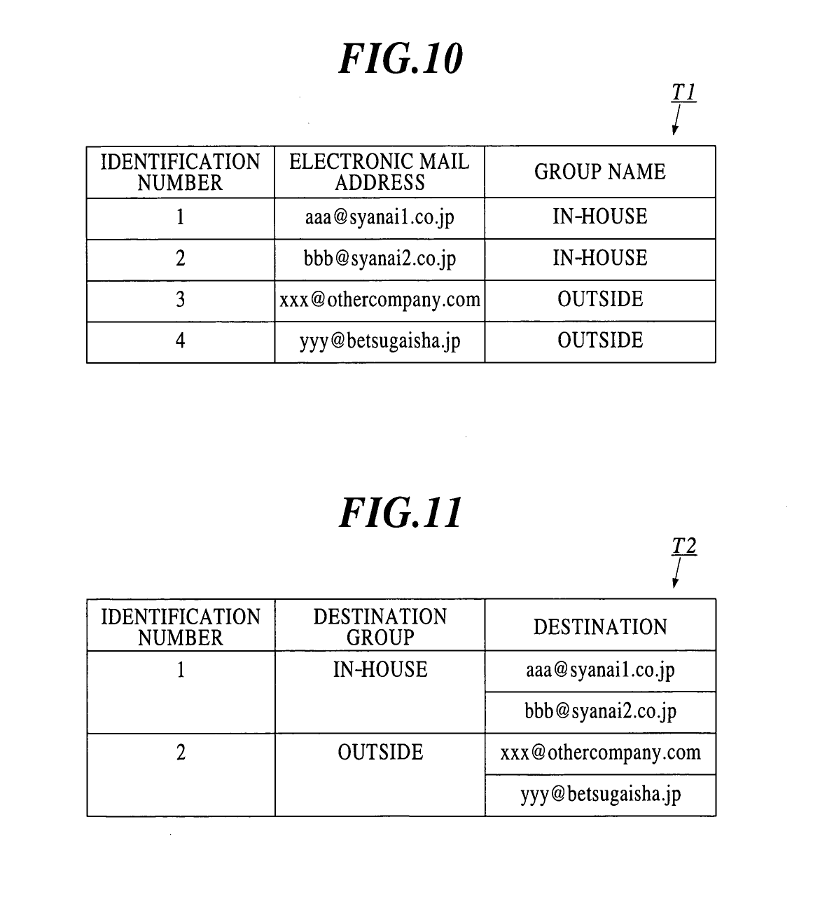

FIG. 11 is one example of a registration table T2 in the case that step S32 is Yes. As shown in FIG. 11, the electronic mail addresses are registered to the registration table T2 as the destination corresponding to the destination group (each group name) where the identification number is given.

After all the electronic mail addresses are registered to the registration table T2 as the destination with respect to each destination group (after step S32; Yes), the reference destination group number M is initialized (set as M=1) (step S33).

The header data is formed according to the electronic mail addresses registered to the destination of the reference destination group number M (step S34), the message obtained in step S2 is attached to the formed header data, so that the electronic mail corresponding to the reference destination group number M is formed (step S35).

After the electronic mail corresponding to the reference destination group number M is formed, presence or absence of the destination group to which the electronic mail has not been made is judged (step S36). When it is judged that there is the destination group to which the electronic mail has not been made (step S36; No), 1 is added to the reference destination group number M (step S37), and the process shifts to step S34.

When it is judged that there is no destination group to which the electronic mail has not been made (step S36; Yes), the process of a group classification according to an address book DB ends and the process shifts to step S14 of the main flowchart.

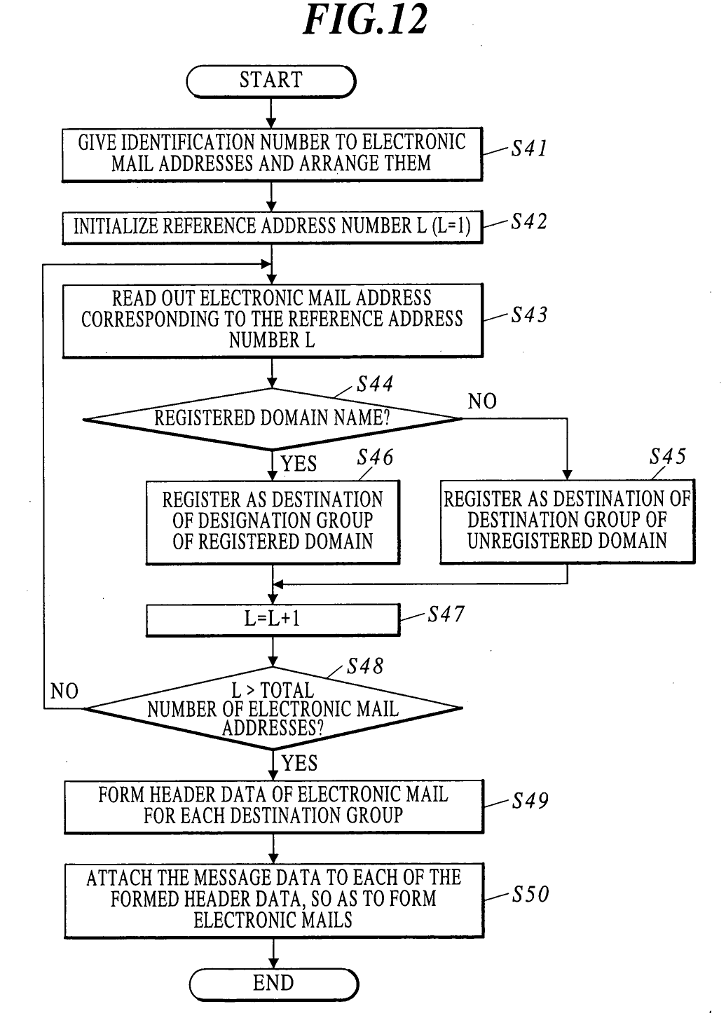

FIG. 12 is a flowchart in the case of determining the group classification according to a domain DB, executed in step S11.

When it is judged that the classification to groups is performed based on the domain DB, for example, the radio button R2 is checked, the identification numbers are given to each of the obtained electronic mail addresses, and the electronic mail addresses are sorted in the identification number order (step S41).

After the electronic mail addresses are arranged, a reference address number L, which is the identification number of the electronic mail address to be referred, is initialized (set as L=1) (step S42). The electronic mail address corresponding to the reference address number N is read out from the arranged list of the electronic mail address (step S43), and it is judged whether the domain name of the read electronic mail address is same as the domain name registered to the domain DB or not (step S44).

When it is judged that the domain name of the read electronic mail address is not the domain name registered to the domain DB (step S44; No), the read electronic mail address is registered as the destination of the destination group of unregistered domain name (step S45).

When it is judged that the domain number of the read electronic mail address is the domain name registered to the domain DB (step S44; Yes), the read electronic mail address is registered as the destination of the destination group corresponding to the registered domain name (step S46).

After the read electronic mail address is registered as the destination (after step S45 or S46), 1 is added to the reference address number L (step S47), and it is judged whether the reference address number L is larger than the total number of the electronic mail addresses or not (step S48).

When it is judged that the reference address number N is not larger than the total number of the electronic mail addresses (step S48; No), the process is back to step S43.

When it is judged that the reference address number N is larger than the total number of the electronic mail addresses (step S48; Yes), all the electronic mail addresses are registered as the destination with respect to the destination group.

The header data are formed to each destination groups based on the electronic mail addresses registered as the destination of designation groups (step S49), the message obtained in step S2 is attached to each of the formed header data, so that the electronic mails are formed for each destination group (step S50), and the process of the group classification according to a domain DB ends. Then, the process shifts to step S14 of the main flowchart.

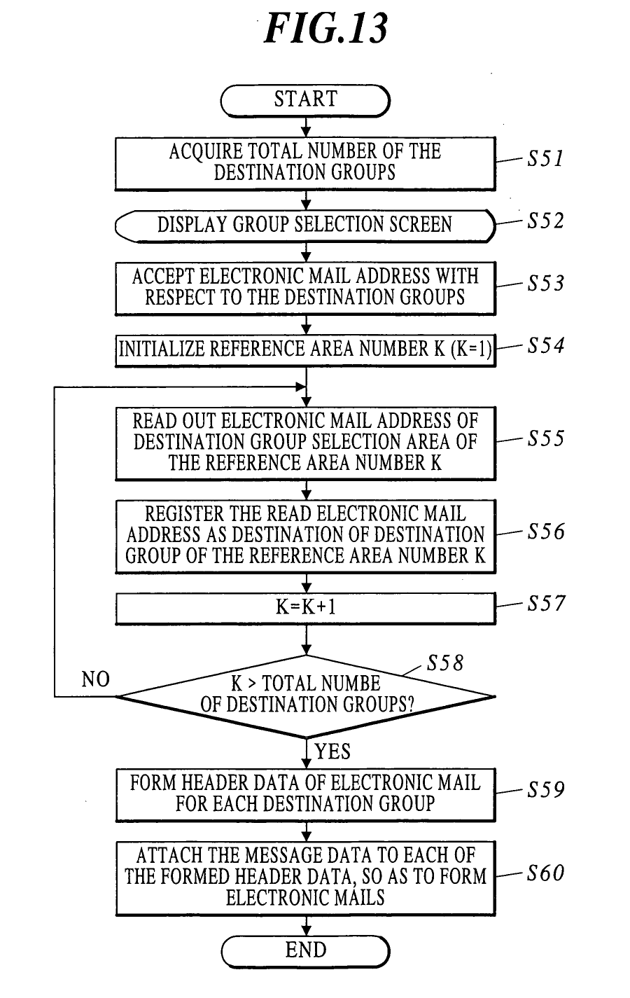

FIG. 13 shows a flowchart in the case of classifying into a plurality of groups according to a selection designation of the electronic mail addresses directed by a user, executed in step S13.

When it is judged that the classification to groups is set to each of the electronic mail addresses, for example, the radio button R3 is checked, an input screen (not shown) to allow the user to designate the total number to the destination groups is displayed on the display screen of the display 13, the user's designation regarding the total number of the destination group is accepted, and the total number of the destination group is obtained (step S51).

A destination group selection area is displayed, which corresponds to the obtained total number of the destination group (step S52).

The user selects a radio button on the group selection screen displayed on the display screen of the display 13. When the OK button B1 is pushed, a selection of the electronic mail addresses each corresponding to destination group selection area is accepted (step S53). An identification number is given to each destination group selection area in order to identify the area.

A reference area number K, which is the identification number of the destination group selection area on the group selection screen, is initialized (set as K=1) (step S54).

The electronic mail addresses corresponding to the reference area number K is read out, and the read electronic mail address is registered as the destination of the destination group corresponding to the reference area number K (step S56).

After the read electronic mail address is registered as the destination (after step S56), 1 is added to the reference area number K (step S57), and it is judged whether the reference area number K is larger than the total number of the destination groups obtained in step S51 (step S58).

When it is judged that the reference area number K is not larger than the total number of the destination groups (step S58; No), the process is back to step S55.

When it is judged that the reference area number K is larger than the total number of the destination groups (step S58; Yes), all the electronic mail addresses are registered as the destination with respect to the destination group.

With respect to the destination group, the header data is formed based on the electronic mail addresses registered as the destination of each destination group (step S59), the message obtained in step S2 is attached to each of the formed header data, so that the electronic mails are formed for each destination group (step S60), and the process of setting classification to groups to each of the electronic mail addresses ends. Then, the process shifts to step S14 of the main flowchart.

As described above, according to the embodiment 1, a plurality of mail addresses can be classified into a plurality of groups when a plurality of the electronic mail addresses are accepted. The electronic mails each of which has electronic mail addresses classified into only one group as the destination and common message data which is the accepted message data are formed and sent. Thus, the user can be saved from the trouble of forming the electronic mails for each of the groups (the trouble of classifying the electronic mail addresses and inputting message data to every groups), so that it becomes possible to improve usability. Further, it also becomes possible to improve efficiency of sending the electronic mails, since number of the sending becomes one.

### Embodiment 2

Hereinafter, embodiment 2 of the present invention will be described in detail with reference to the drawings.

An electronic mail system A of embodiment 2 schematically has similar constitution with that of the embodiment 1, except the terminal apparatus 1 of the embodiment 1 is changed to a terminal apparatus 3. Therefore, the drawings and descriptions thereof will be omitted.

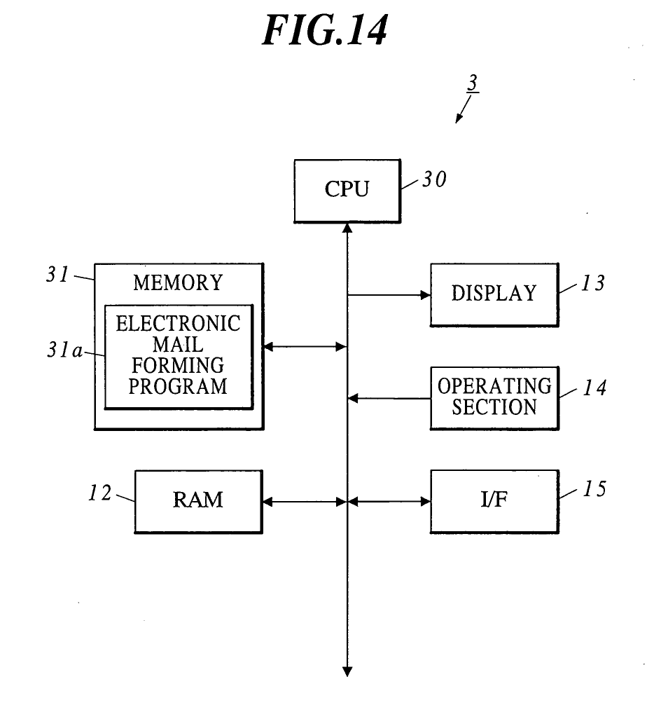

FIG. 14 shows a control block diagram of a terminal apparatus 3 of embodiment 2.

In the control block diagram of a terminal apparatus 3 shown in FIG. 14, same reference numerals are given to blocks which are same as the control blocks of terminal apparatus 1, and the descriptions thereof are omitted. Descriptions are only given to the different blocks.

As shown in FIG. 14, the terminal apparatus 3 comprises a CPU 30, memory 12, RAM 12, display 13, operating section 14, and I/F 15, which are connected with one another.

The CPU 30 reads out a system program, various processing program and various data, expands them to the RAM 12, and performs a central control of operations of each section in the terminal apparatus 3 according to the expanded programs and data. The CPU 10 controls timing of the whole system, storing of data by use of the RAM 12 and operation with respect to other applications.

When an electronic mail forming program is executed, the CPU 10 offers an address input step, classification step, electronic mail forming step and sending step, which accept electronic mail addresses on an input columns (destination group input columns) for accepting electronic mail addresses, the previously determined number of the column being displayed on an electronic mail forming screen which accepts information required to form an electronic mail such as header data and message data, classify the accepted electronic mail addresses with respect to the destination group input column, form a plurality of electronic mails each of which have destinations of only one group of the classified mail addresses and common message data which is the accepted message data, and send the formed plural electronic mails.

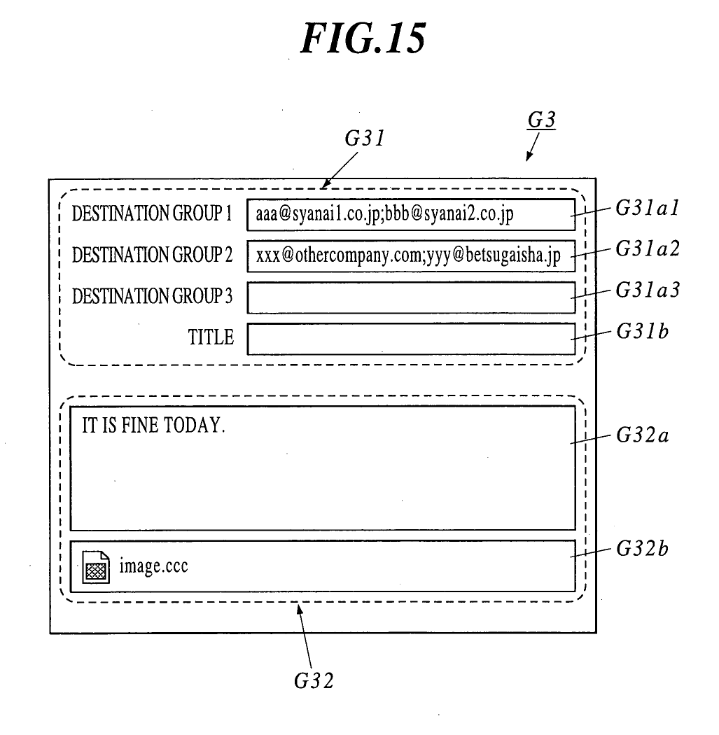

FIG. 15 shows one example of an electronic mail forming screen G3 of the embodiment 2.

As shown in FIG. 15, the electronic mail forming screen G3 comprises a header input area G31 and message input area G32. The header input area G31 comprises a plurality of destination group input columns G31a1, G31a2 and G31a3 which are previously set, title input column G31b to which a title of an electronic mail are input, and the like. The message input area G32 comprises a message body input area G32a to which a message body of the electronic mail is input, and attached document input area G32b to which an attached document is input.

The previously set number of destination group input columns are shown as the input areas to accept electronic mail addresses in FIG. 15 (three columns in FIG. 15). New destination group input column may be formed every time an electronic mail address is newly input to the destination group input column, or new destination group input column may be formed according to an operation on the operating section 14. The present invention is not limited to these embodiments, as far as a plurality of destination group input columns are provided.

The memory 31 comprises a nonvolatile recording medium such as ROM and HDD, and stores in the recording medium a system program corresponding to the terminal apparatus 3, various control programs and various application programs executed by the CPU 10, and various data required to process on the various programs.

Further, the memory 31 previously stores an electronic mail sending and receiving program executed in embodiment 2 which is to manage sending and receiving of the electronic mail between the mail server 2 and terminal apparatus 3, an electronic mail forming program 31a executed in the electronic mail sending and receiving program, and various data required to form an electronic mail.

Next, operation of embodiment 2 will be explained.

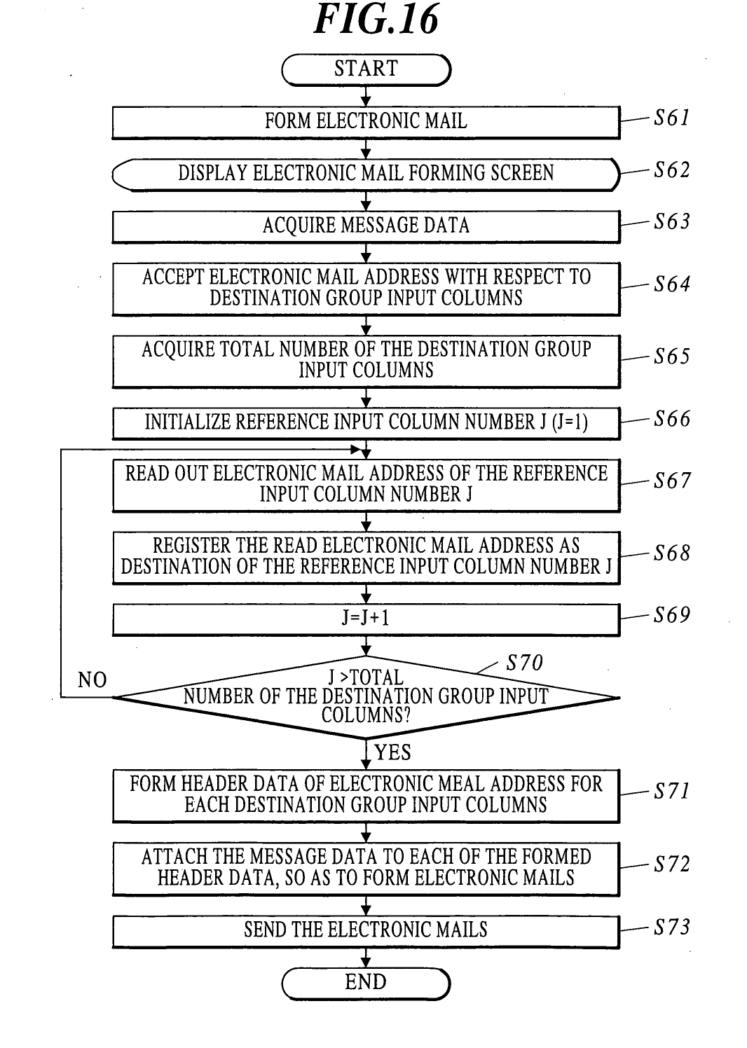

FIG. 16 is a flowchart of an electronic mail forming process of embodiment 2.

The flowchart of the electronic mail forming process shown in FIG. 16 is offered by software processing which is achieved by cooperation of the CPU 30, memory 31 and the programs and various data stored in the RAM 12.

First, when the operating section 14 accepts a designation of the user to form new mail (step S61), the display 13 displays a new electronic mail screen G3 on the display screen (step S62). The user inputs message data from the operating section 14 to the new electronic mail screen G3, so that the message data is obtained (step S63), and the user also inputs electronic mail addresses to each destination group input column as header data, so that the header data is obtained (step S64).

When the header data is obtained, the total number of the destination group input columns to which the electronic mail addresses are detected, so that the detected total number of the destination group input column is obtained (step S65). Further, identification numbers to identify destination group input columns each other are given to the destination group input columns to which the electronic mail addresses has been input.

A reference input column number J, which is the identification number of the destination group input column to be referred, is initialized (set as J=1) (step S66).

The electronic mail addresses corresponding to the input reference input column number J is read out (step S67), and the read electronic mail address is registered as destination of the destination group corresponding to the reference input column number J (step S68).

After the read electronic mail addresses are registered as the destination (after step S68), 1 is added to the reference input column number J (step S69), and it is judged whether the reference input column number J is larger than the total number of the destination group input columns obtained in step S65 or not (step S70).

When it is judged that the reference input column number J is not larger than the total number of the destination group input columns (step S70; No), the process shifts to step S67.

When it is judged that the reference input column number J is larger than the total number of the destination group input columns (step S70; Yes), all the electronic mail addresses are registered as the destination with respect to the destination group input columns.

The header data is formed with respect to the destination group input columns according to the electronic mail addresses registered as the destination (step S71), the message obtained in step S63 is attached to each of the formed header data, so that the electronic mails are formed with respect to the destination group input columns (step S72).

The formed electronic mails are sent to the electronic mail address set as the destination (step S73) and the process ends.

As described above, according to the embodiment 2, electronic mail addresses are accepted with reference to the destination group input columns (with reference to the input columns of the electronic mail addresses), and the electronic mail addresses can be classified into the destination group input columns. Thus, the electronic mail addresses can be classified into groups according to the user's desire. A plurality of electronic mails each of which have destinations of only one group of the classified mail addresses and common message data which is the accepted message data are formed and sent. Thus, the user can be saved from the trouble of forming the electronic mails with respect to the groups (the trouble of classifying the electronic mail addresses and inputting message data to every groups), so that it becomes possible to improve usability. Further, it also becomes possible to improve efficiency of sending the electronic mails, since number of the sending becomes one.

The present invention is not limited to the above-described embodiment, and can be optionally modified within the scope of the invention.

What is claimed is:

1. An electronic mail forming method comprising the steps of:
classifying a plurality of electronic mail addresses into a plurality of groups;
forming, for each of the groups classified in the classifying step, at least one electronic mails in which only electronic mail address(es) classified into the corresponding one of the groups is designated as destination(s); and
sending the electronic mails formed in the forming step.

2. The method of claim 1, further comprising the step of:
accepting an input of a plurality of the electronic mail addresses,
wherein in the classifying, a plurality of the electronic mail addresses accepted in the accepting are classified into a plurality of the groups.

3. The method of claim 2, wherein in the accepting step, message data is accepted, and
in the forming step, the message data accepted in the accepting is applied as common message data to the classified groups.

4. The method of claim 1, further comprising the step of:
setting a group number by accepting an indication of the number of the groups to which the electronic mails are classified,
wherein in the classifying step, a plurality of the electronic mails are classified according to the group number accepted in the setting step.

5. The method of claim 1, wherein in the classifying step, a selection of the group is requested for each of the electronic mail addresses.

6. The method of claim 1, wherein in the classifying step, a plurality of the electronic mail addresses are classified into a plurality of the groups according to domain names included in the electronic mail addresses accepted in the accepting step.

7. The method of claim 1, wherein in the classifying step, a plurality of the electronic mail addresses are classified into a plurality of the groups based on a predetermined rule.

8. The method of claim 7, wherein the predetermined rule includes referring to a list of the electronic mail addresses in which the electronic mail addresses correspond to attribute information, and
in the classifying step, a plurality of the electronic mail addresses are classified into a plurality of the groups according to the attribute information.

9. The method of claim 8, wherein in the classifying step, the electronic mail addresses to which the attribute information is not set are classified into a group different from the group(s) of the electronic mail addresses to which the attribute information is set.

10. The method of claim 1, wherein the classifying step comprises the step of accepting an input of the electronic mail addresses with respect to the groups.

11. The method of claim 10, wherein in the accepting step of the input of the electronic mail addresses, input columns of the electronic mail addresses are provided in which the number of the input columns corresponds to a predetermined number of the groups, and
in the classifying step, the electronic mail addresses are classified with respect to the input columns to which the electronic mail addresses have been input.

12. A recording medium which stores a computer-executable program, the program causing a computer to carry out the procedures of:
classifying a plurality of electronic mail addresses into a plurality of groups;
forming, for each of the groups classified in the classifying step, at least one electronic mail in which only electronic mail address(es) classified into the corresponding one of the groups is designated as destination(s); and
sending the electronic mails formed in the forming procedure.

13. The recording medium of claim 12, wherein the program further causes the computer to carry out the procedure of:
accepting an input of a plurality of the electronic mail addresses, and
in the classifying procedure, a plurality of the electronic mail addresses accepted in the accepting are classified into a plurality of the groups.

14. The medium of claim 13, wherein in the accepting procedure, message data is accepted, and
in the forming procedure, the message data accepted in the accepting procedure is applied as common message data to the classified groups.

15. The medium of claim 12, wherein the program further causes the computer to carry out the procedure of:
setting a group number by accepting an indication of the number of the groups to which the electronic mails are classified, and
in the classifying procedure, a plurality of the electronic mails are classified according to the group number accepted in the setting.

16. The medium of claim 12, wherein in the classifying procedure, a selection of the group is requested for each of the electronic mail addresses.

17. The medium of claim 12, wherein in the classifying procedure, a plurality of the electronic mail addresses are classified into a plurality of the groups according to domain names included in the electronic mail addresses accepted in the accepting procedure.

18. The medium of claim 12, wherein in the classifying procedure, a plurality of the electronic mail addresses are classified into a plurality of the groups based on a predetermined rule.

19. The medium of claim 13, wherein the predetermined rule includes referring to a list of the electronic mail addresses in which the electronic mail addresses corresponds to attribute information, and
in the classifying procedure, a plurality of the electronic mail addresses are classified into a plurality of the groups according to the attribute information.

20. The medium of claim 19, wherein in the classifying procedure, the electronic mail addresses to which the attribute information are not set is classified into a group different from the group(s) of the electronic mail addresses to which the attribute information is set.

21. The medium of claim 12, wherein the classifying procedure comprises a procedure of accepting an input of the electronic mail addresses with respect to the groups.

22. The medium of claim 21, wherein in the accepting procedure of accepting the input of the electronic mail addresses, input columns of the electronic mail addresses are provided in which the number of the input columns corresponds to a predetermined number of the groups, and
in the classifying procedure, the electronic mail addresses are classified with respect to the input columns to which the electronic mail addresses have been input.
